(19) United States
(12) Patent Application Publication
(10) Pub. No.: US 2004/0046709 A1
(43) Pub. Date: Mar. 11, 2004

(54) 3 Dimensional image projector and holodeck

(76) Inventor: Kazutora Yoshino, Madison, WI (US)

Correspondence Address: Yoshino, Kazutora, 226 N. Hillside Tr., Madison, WI, 53705, US

(21) Appl. No.: 10/235,575

(22) Filed: Sep. 5, 2002

(51) Int. Cl. G09G 5/00

(52) U.S. Cl. 345/6

(57) ABSTRACT

By this invention, multi-users can view the 3 dimensional objects or images in real time (run time) without special glasses in the space or in the air or in space as the result of emitting light from points where beams merges in materials.

### FEDERALLY SPONSORED RESEARCH

Not Applicable

### SEQUENCE LISTING OR PROGRAM

Not Applicable

### BACKGROUND OF INVENTION

1. Field of Invention

This invention relates to the image display devices, specifically to 3DTV, hologram, stereo display device that are used for displaying the 3 dimensional object or images and 3D scanners. 2. Description of Prior Art

In the conventional way, it was difficult to display the 3 dimensional object or images in real time (run time) by viewed by the multiple users without special glasses in the space only by light. So devices such as TV are showing the converted 2 dimensional image from the 3 dimensional objects. Also, the virtual headsets are showing the two different images to each eye of users by screens to create the 3 dimensional images. Also, holograms are showing 3 dimensional image, but these images are difficult to be changed in real time (run time). Also, the method to project the 2 dimensional image to rotating plate to create 3 dimensional image are difficult to show the 3 dimensional virtual images in the space only by light. Also, the method to project the 2 dimensional image to semi-transparent plates to create 3 dimensional image are difficult to show the 3 dimensional virtual images in the space only by light. In other words, user cannot touch these 3 dimensional images to interact directly with the 3D image. These are like U.S. Pat. No. 5,394,202 (Deering, 1995) and U.S. Pat. No. 5,907,312 (Sato, et al, 1999).

In Japanese Patent No 288957, Felix Gashia, et al. shows the way to make 3 dimensional image by project the 2 dimensional image to rotating plate. This put red, blue, green laser beam together to light fiber, and run the light to make the 2 dimensional image on the angled and rotated plate so that it would show the 3 dimensional image as a result. But, this one is rotating fast; this is not too safe to users. And therefore, it is not suitable for user to touch the 3 dimensional image. Also, this by itself is almost impossible to show the image in the space only by light.

In the Lab note made by Kazutora Yoshino (May 30, 1995), or in U.S. Patent application No. 60/004,111(1995), or in U.S. Pat. No. 6,302,542 (1999) Tsao shows that the movement of panel/screen with 2D image projected on it can make 3D images. They show little information how fast the panel/screen should movement is made practically nor they show little mechanism how to move the panels/screens effectively in order to make the 3D image realistic. Also, users cannot touch to the 3D image in this method. Also, even when a viewer likes to see background sight through the object, a screen stops the background sight and the viewer could not see the back ground sight. Also, there was a problem such that the movement of back and force in slider-crankshaft-wheel system is harmonic so that the panel movement in space in time was not equally spaced, therefore, the 3D image doesn't become proportional if image is displayed in a constant timing. Also, in most cases of current technology, 2D image from previously made 2D pictures are projected screen that moves to make 3D image. But in this method, it can display only previously made 3D images only or it is not fast enough for users to interact. This is a problem when users try to interact with 3D images. Also, there was a problem such that when the 2D image was projected a screen, 3D image is too light for viewer to see especially in bright environment since the projection of optic 2D picture image on screen gives light image. In U.S. Pat. No. 5,956,172 (1999) and No. 5,684,621 (1997) by Elizabeth Anne Downing, it shows the way to display the 3D image in a crystal. But user still cannot touch to the 3D image. Also, coupling (intersecting) two light beams is difficult and expensive in many cases since it need to use more direction specifying device such as galvanometers. Also, it is difficult and expensive to create big crystal used in these methods. Also, these methods do not show how to make full color 3D image. It may show only red, green and green color.

In U.S. Pat. No. 3,647,284, (1970) Virgil B Ethlgs, et al. show the method of showing 3 dimensional image made by the light that was originally scattered by an object. This device put two dish means facing each other. The top dish means has a hole in the middle and 3 dimensional image shows up over this hole when user put the object at the bottom of the bottom dish means. But this device by itself would be unsuitable to show the real time (run time) 3 dimensional image.

In U.S. Pat. No. 5,899,861 (1999) Friemel et al. shows the way to acquire the baby image in a body. The system uses the echo of ultrasound to acquire the image of the baby.

In U.S. Pat. No. 5,818,959, Webb, Jon A. shows the making 3D image from 2D images identifying the same points in the picture. But there is not clear description of how to find the identical point in 2 dimensional images that is difficult to practice.

There is a method to use triangular red laser beam or meshed pattern on an object to scan the 3D image in the field of reverse engineering.

Neither of these is integrated enough to acquire and show the 3D images purely in the air with the change of images in real time. That is, displaying the 3D image that user can touch instantly after acquiring the 3D image.

### OBJECTS AND ADVANTAGES

This invention has advantages relative to prior art in

1. The device can display the 3 dimensional images immediately after the data has been acquired.

2. The device can display the 3 dimensional object or images that can be viewed by the multiple users without special glasses

3. The device can display the 3 dimensional object or images in the space.

4. The viewer may see the background sight s/he can see through 3D image.

5. Relatively, cost efficient.

6. It can run on complete system.

7. No container is necessary in the space for the 3D image.

8. Relatively brighter image than the most of the other 3D display.

9. Relatively clearer and higher resolution of 3D image.

10. Relatively smaller instrument and bigger 3D image.

### SUMMARY

This device of invention can display the 3 dimensional objects or images in real time (run time) by the multiple users without special glasses in the space.

General concept of the device is to acquire the 3D image from its input device means using optical camera, optical video, laser scanner, ultrasound. Or one can make 3D image using design program such as CAD program by computers. Then a 3D image generator displays the acquired 3D images or generated 3D images. In order to display the 3D image, it runs the light emitting point means in the 3 dimensional spaces so fast that the resultant light image creates 3 dimensional image.

When a beam or beams with enough energy enters material means such as plasma such as air plasma like oxygen plasma & nitrogen plasma or gas like argon, helium, and air or liquid like liquid crystal, and solid such as a crystal, glass, plastic, the material means emits the light from the point. Usually, projecting invisible beams such as infrared light to let the material means such as crystal, gas, and plasma to emit visible light such as red light is what is practical. For example, microwave beam creates a plasma and plasma glow emitting photons with gases. By concentrating beams such that each has energy less than the thresholds yet when they are gathered into a same spot, it would have the energy that goes beyond the thresholds to emit the photon(s).

In this method, the device can generate 3D created image in the middle of air using air plasma (oxygen and nitrogen plasma) as the result of beams projections. Also, the device can generate 3D created image in a gas within a container as the result of light emission from the gas at the focused point where beams are projected.

If gas, liquid, solid such as crystal is volumetric, the concentration of such beam is necessary. But, if the gas, liquid, solid such as crystal has thin layer, the beam entrance to the thin layer creates a point where it is bright, that is, it creates the virtual point.

By running virtual point very fast (preferably 70 images/sec or greater) or distributing the virtual points, a device can create 3 dimensional image(s). If the thin layer of gas, liquid, solid such as crystal is used, those need to be moved to create 3 dimensional image(s).

When 3D core image is made by 3D core image generator, if the 3D core image is not touchable, the system can have 3D core image lifting means such as inside reflective curved surface means, lens, and reflectors. For example, if the 3D core image is mad in a crystal, it can be embedded to inside reflective dishes-like container or an inside reflective sphere/bowl-like container. The sphere/bowl-like container can be half clear material so that viewer may be able to see the background sight through the image. Also, using simple lens in front of 3D core image can bring the image in front of viewers.

As for the case of the invention that the diffuser/reflector means move with image projection generates the 3D created image, it gives better 3D image when position/motion feed back system is introduced using sensing devices such as encoders, potentiometer, switch ultrasound position reader, motion sensor, gyroscopes direction sensor.

In order to make the position control practical, controlling system means such as pulse width method (PWM) control for DC motor and position sensing device such as encoders (and stepping motor driver and stepping motor, etc.) can be used so that it would not simple reciprocating motion but can choose the designated z coordinate position at right time.

Also a couple of oval gears can be used to modify the speed of rotation so that the special movement in time becomes more uniform comparing to the harmonic movement which is generated by a slider-crankshaft-wheel system.

In order to solve the problem such that 2D image projection on moving screen can display only previously made 3D image or it is too slow to interact or it, the invention can register the data of 0 dimensional image, ID image, 2D image, and 3D image and it sends the information to the image driver means with timing device so that it can have enough images on the moving panel and therefore it generates 3D created image for user to interact.

This invention is innovative on the fact that it uses movement of a layer or layers of the material means such as crystal, plasma gas, gas, special paper/plastic that emit bright light when beam enters to those materials so that when image is made though this system, it gives bright 3D created image as the result of image emitting and movement of a layer or layers of the material means. This solves the problem such that 3D image is too light to see in the bright environment. (Also putting higher power of beam can solve the problem, but this is usually more expensive to do.)

Also, this invention solves the problem such that the controlling devices for coupling beams are expensive since when a beam enters to a point on a layer or layers of those material means, only the point emits the light rays so that the beam does not have to be coupled in this method, which reduce the cost to make.

Also, this invention solves the problem such that viewer could not see the background sight when a screen was used since the screen blocks the background sigh as well in order to capture 2D image. This is because the material means such as plasma, gas or crystal can be clear or clear enough so that viewer can see the background sight through them, meanwhile those material can still emit the light rays for image on the necessary positions.

As for the case of the invention using crystal, in order to solve the limited color graphics, the invention uses timed beam each of which correspond to emission of each color such as red, green and blue. This may be done by pulse width method (PWM) that sends the signals that has different width of pulses having certain intervals of frequency between pulses. This therefore leads emit beam and emit the photons of red, green and blue color wavelength. The fast sequential timing of these color light creates the full color of 3D image for viewer's eyes.

Also in order to make this 3D image touchable to user, the system may use the 3D core image lifting means such as dishes-like surface with a hole and lens means.

### DRAWINGS

Drawing Figures

FIG. 1 shows the example diagram of a 3 dimensional image projector displaying a 3D created image in the air.

FIG. 1_A1 shows the example diagram of 3 dimensional image generator means that create 3 dimensional created image by focusing the beam means into material means and by moving the focus controlled by x, y, and z axis control means with/without density control.

FIG. 1_A2 shows the example diagrams of the 3 dimensional image generator means that create 3 dimensional created image using container means and material means with/without image lifting means.

FIG. 1_A3 shows the example diagrams of the more detail of 3 dimensional image generator means that create 3 dimensional created image by focusing the beam means into material means and by moving the focus controlled by x, y, and z axis control means with/without density control.

FIG. 1_A4 shows the example diagram that plasma discharge and/or arc discharge is used to create 3D created image with example components of electrodes, gas, and the timing device for the pulse.

FIG. 2 shows the example diagrams of 3D image generator means. A material means such as crystal, gas, and plasma with/without container with x-y-z position controller such as acoustic-optic defector, electro-optic prism, polygon scanner, galvanometer and their drivers that is contained by inside reflective curved surface with holes. Ultrasound scanner is acquiring the 3D image data and user interface input device means are used in this example.

FIG. 2_A1 shows the example component strabismus diagrams of 3D image generator means.

FIG. 2_A2 shows the alternative example diagrams of 3D image generator means.

FIG. 2_A3 shows the example diagrams of 3D image generator means where beam means enters material means such as crystal, gas, and plasma with/without the usage of signal control means such as PWM control.

FIG. 2_A4 shows the alternative example diagrams of 3D image generator means with magnification means with different curvature (or dishes-like) reflective surfaces and lenses.

FIG. 2_A5 shows the alternative example diagrams of 3D image generator means with magnification means with different curvature (sphere/bowl/parabola-like) reflective surfaces and lenses.

FIG. 2_A7 shows the alternative example diagrams of 3D image generator means with magnification means with different curvature (sphere/bowl/half dome/parabola-like) reflective surfaces and lenses.

FIG. 2_A8 shows the example diagrams of 3D image core generator.

FIG. 3 shows the example diagrams of 3D image generator means. The motion with a material means such as a layer/layers of crystal, gas, and plasma with/without container with x-y-z position controller such as acoustic-optic defector, electro-optic prism, polygon scanner, galvanometer and their drivers, and the single beam entrance to the material means of the motion generates the 3D created image.

FIG. 3_A1 shows the example diagrams of 3D image generator means. The motion with a material means such as a layer/layers of crystal, gas, and plasma with/without container with x-y-z position controller such as acoustic-optic defector, electro-optic prism, polygon scanner, galvanometer and their drivers, and the multiple beams entrance to the material means of the motion generates the 3D created image.

FIG. 3_A2 shows the example mechanical diagrams of 3D image generator means. The motion with a material means and the normal gears and/or oval gears with rod means, with motor means, position/motion control means such as position/motion sensing device.

FIG. 3_A3 shows the alternative example diagrams of 3D image generator means. The reflector means shift the location and magnifier means changes the size of the 3D core image generated by 3D core image generator.

FIG. 3_A4 shows the alternative example diagrams of 3D image generator means. The motion with a material means such as super conductor together with image projector can generate 3D created image. The motion with a material means such as diffuser in vacuum or gas together with image projector can generate 3D created image. The reciprocating/shift or ration motion of timed 1D/2D image can generate 2D/3D created image.

FIG. 3_A5 shows the alternative example diagrams of 3D image generator means. The reciprocating, and/or rotated motion of tilted plane or display with/without image projector can generate the 3D created image.

FIG. 3_A8 shows the example diagrams of 3D image generator means and its drivers.

FIG. 4 is a copy of diagram drawing made by Kazutora Yoshino in 1995 showing the reciprocating motion of a screen with 2 dimensional image projected/generated can generate the 3D created image. In other words, moving images creates a higher dimensional image.

### REFERENCE NUMERALS IN DRAWINGS

{1} 3 dimensional image generator means

{2} 3 dimensional created image

{3} an image projector such as a point (0 dimensional) mage projector, 1 dimensional image projector, 2 dimensional image projector, 3 dimensional image projector.

{4} beam emitter means such as microwaves emitter, radio wave emitter, photons emitter, electrons emitter, ions emitter, laser, white color laser, red laser, green laser, blue laser, combinations of red, green, blue lasers, infrared laser, ultraviolet-ray laser, x-ray laser, combination of those lasers.

{5} a 3 dimensional core image generator.

{7} 3 dimensional image scanner means

{8} focusing beam means

{10} reflecting focusing beam means

{11} the beam means such as microwaves beam, radio wave beam, beam of photons, beam of electrons, beam of ions, red laser beam, green laser beam, blue laser beam, infrared laser beam, ultraviolet laser beam, x-ray laser beam and combination of such beams.

{12} pressure control

{14} gas means such as air, helium, argon, hydrogen, oxygen, nitrogen, and CH4.

{18} material means such as plasma, gas, liquid, solid a crystal, layers of crystals, liquid crystal, air, argon, helium, a sheet of paper, plastic, glasses, superconductors.

{19} a container for material means

{20} particles emission means such as emission of photons therefore light emission

{21} image lifting means such as a inside reflective dishes-like container a inside reflective sphere/bowl/half dome/parabola-like container a inside reflective surface with curvature reflector, parabola mirror, lens.

{22} inside reflective dishes-like container means

{23} inside reflective sphere/bowl/half dome/parabola-like container means

{25} inside reflective surface with curvature. (examples of materials: full reflective or half reflective glass/plastic, mirror, etc.)

{27} lens means such as optical lens, magnet lenses, combination of lenses, focus changeable lenses such as mechanical movement of lenses, electro-optic lens.

{28} a high voltage electrode

{30} X axis control means

{31} Y axis control means

{32} Z axis control means

{37} an electrode

{38} an anode

{40} a cathode

{42} plasma discharge and/or arc discharge

{50} a 3 dimensional image display

{52} the beam direction changing means such as x, y, z axis control means such as polygon scanner, galvanometer with reflectors, acoustic crystal deflectors, electro-optic prisms/lenses, electric magnets

{53} a driver for the beam changing direction means

{57} drivers and computers

{58} a 3 dimensional image input device such as ultrasound 3 dimensional image reader/scanner

{59} creatures and/or objects such as a patient, human, mother, and plastic models

{70} user interface input devices such as 3 dimensional mouse, 3 dimensional pen.

{73} a fan/spiral disk rotator

{74} a disk rotator

{77} diffuser and/or reflector means of material means and/or container means

{78} motor means such as DC motor, stepping motor, ultrasound motor, superconductor motor.

{79} position and/or motion sensor and control means such as encoders, potentiometers, switches, motion sensors, photo diode, photo transistor.

{80} gear means such as wheels, normal gears, oval gears

{82} rod means

{84} spring means such as metal springs and rubbers

{85} position/motion control means such as PWM controller for motors with feedback information.

{90} observers/vieweres/users

{92} vacuum

{95} 2 dimensional display such as liquid crystal display and plasma display, LED array

{96} 1 dimensional display such as LED array

{97} display timing control means

{98} signal/information control means such as PWM control.

{100} magnet means such as electric magnet, solenoid and magnet.

### DETAILED DESCRIPTION

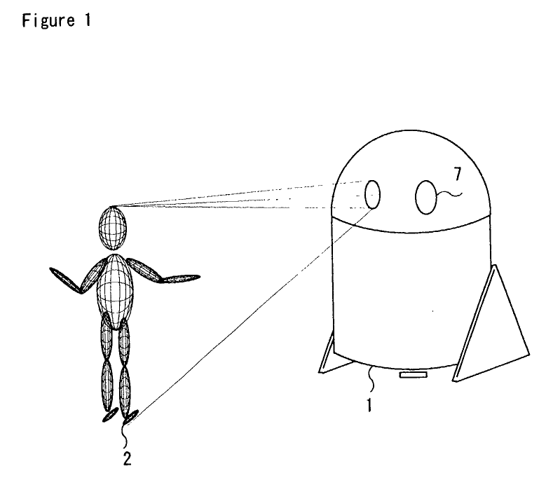

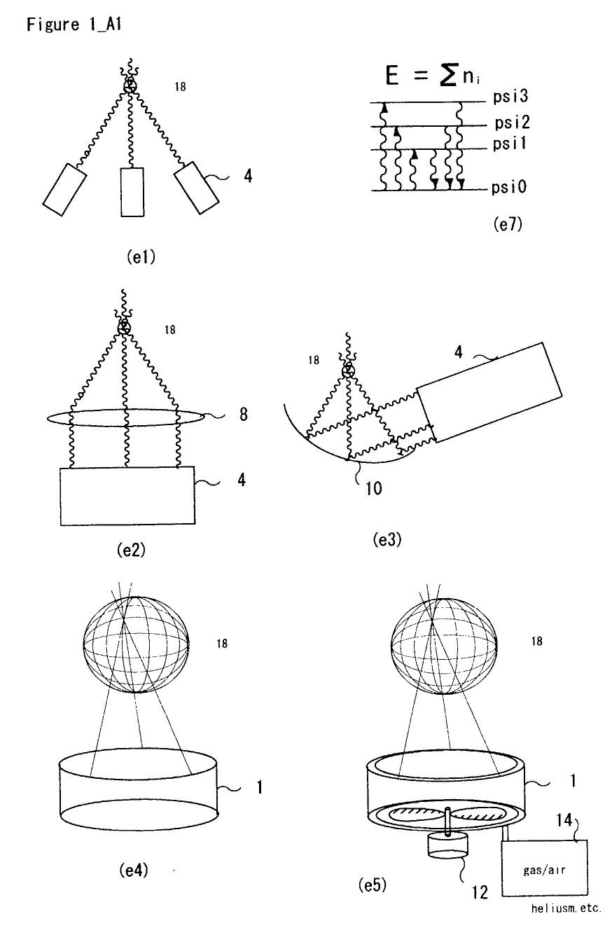

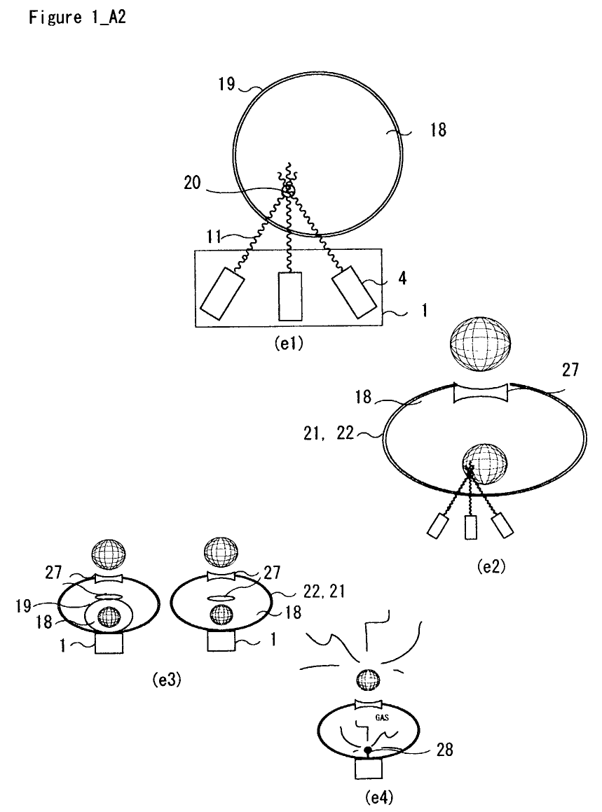

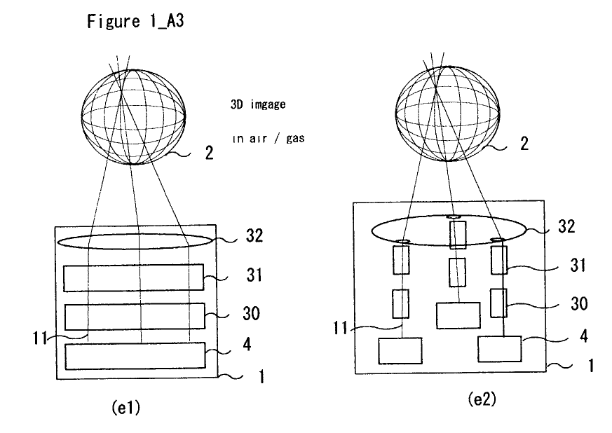

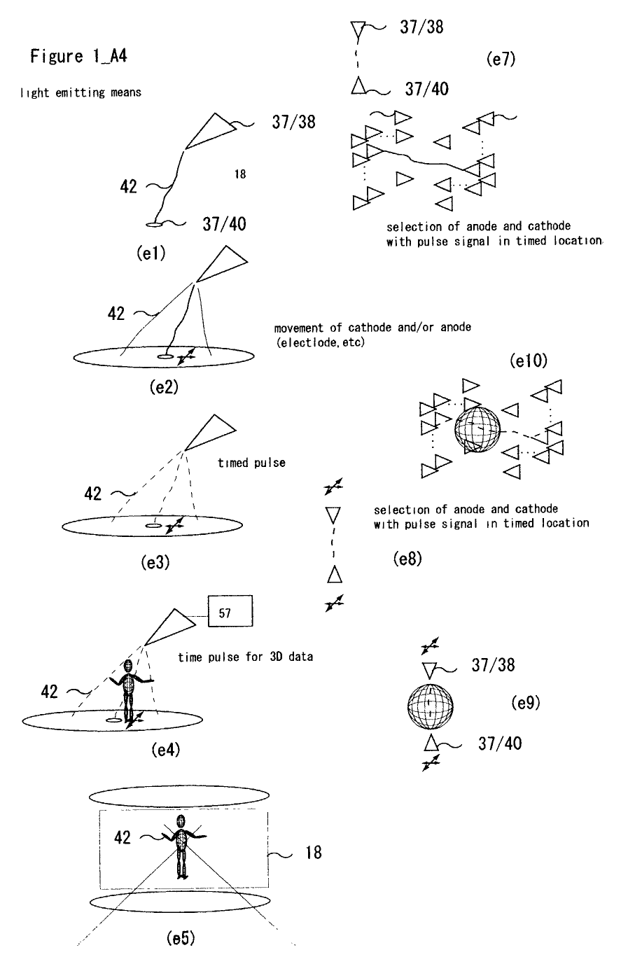

Description—FIGS. 1,2,3, FIG. 1_A3—Preferred Embodiment

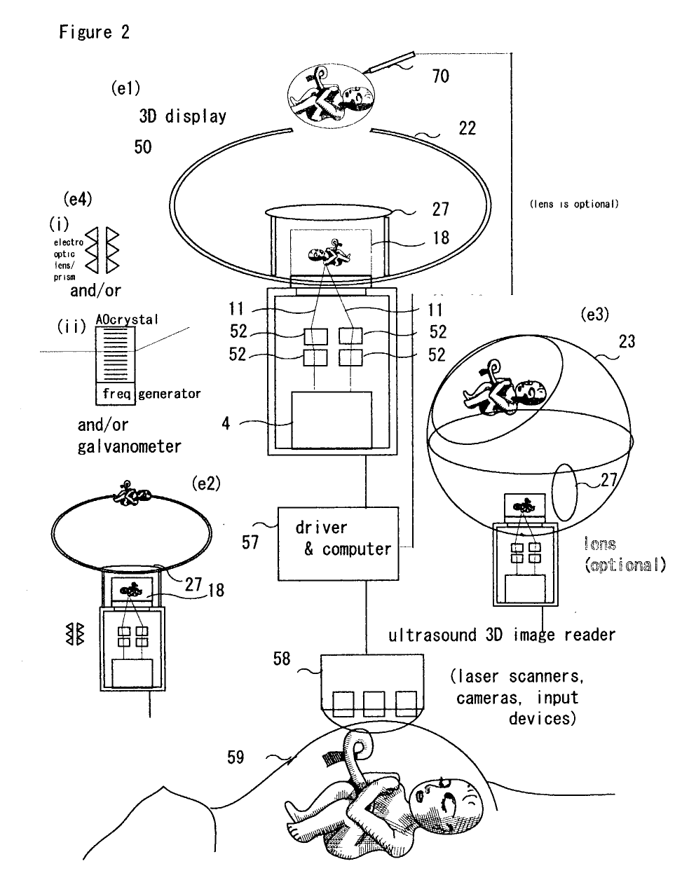

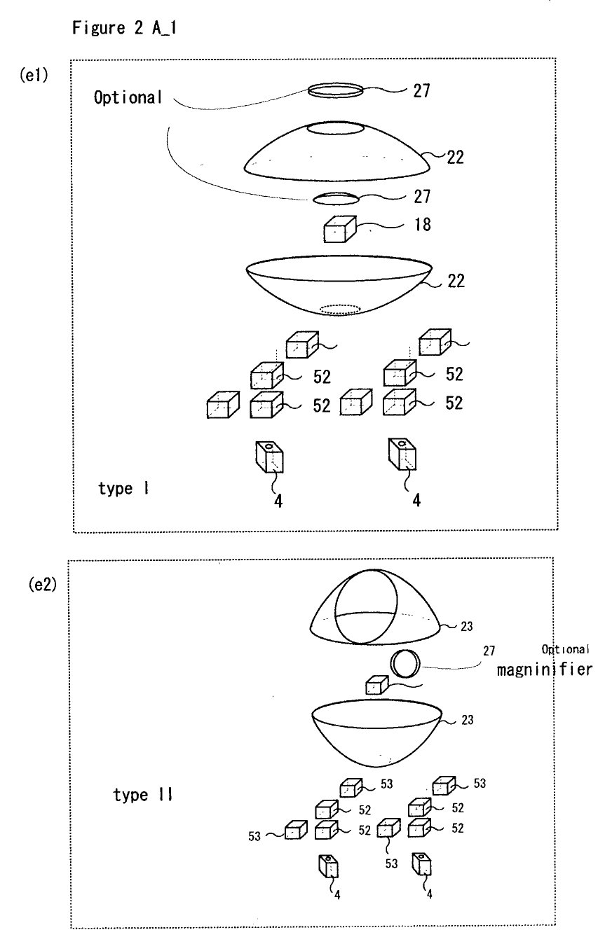

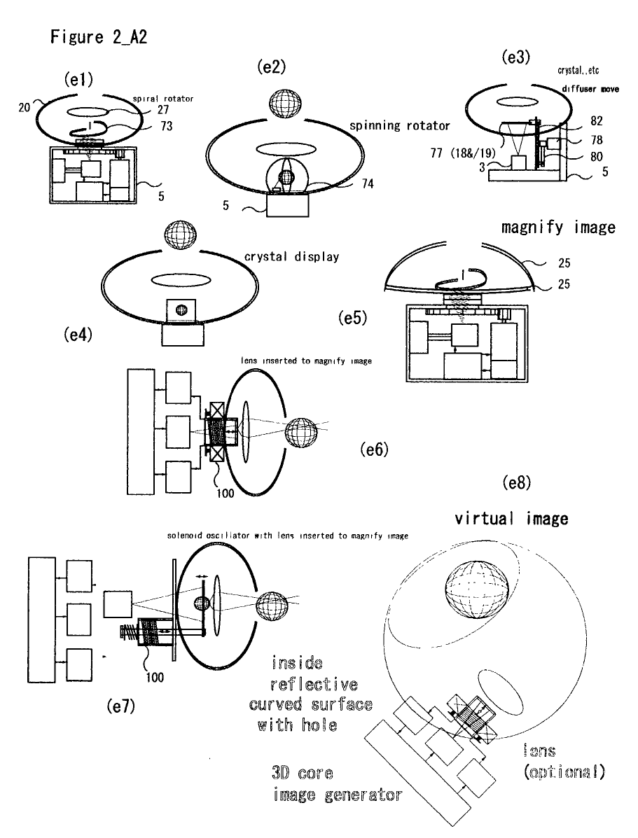

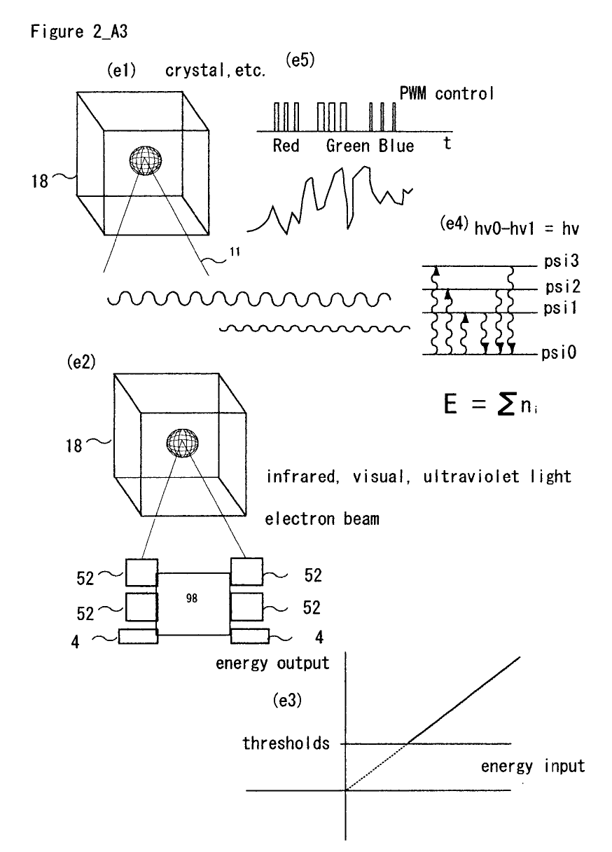

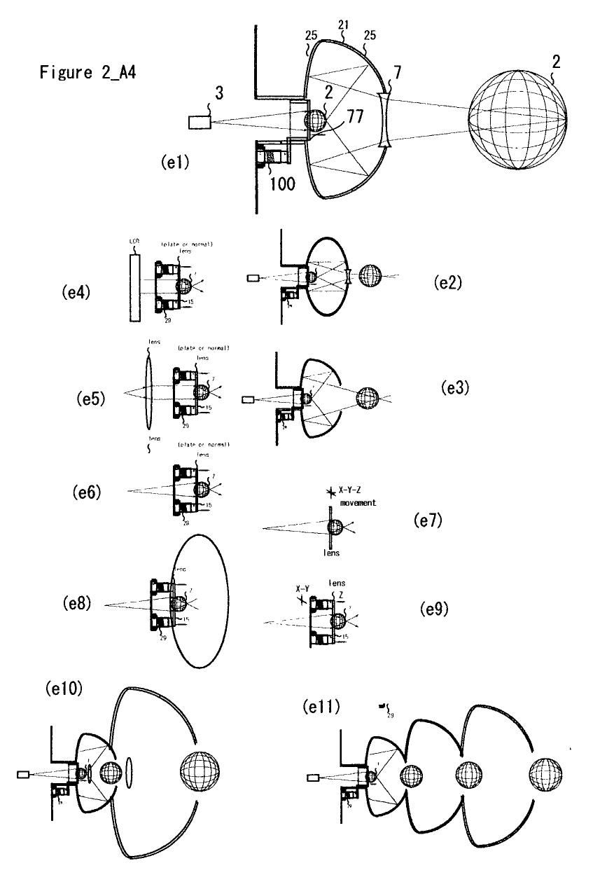

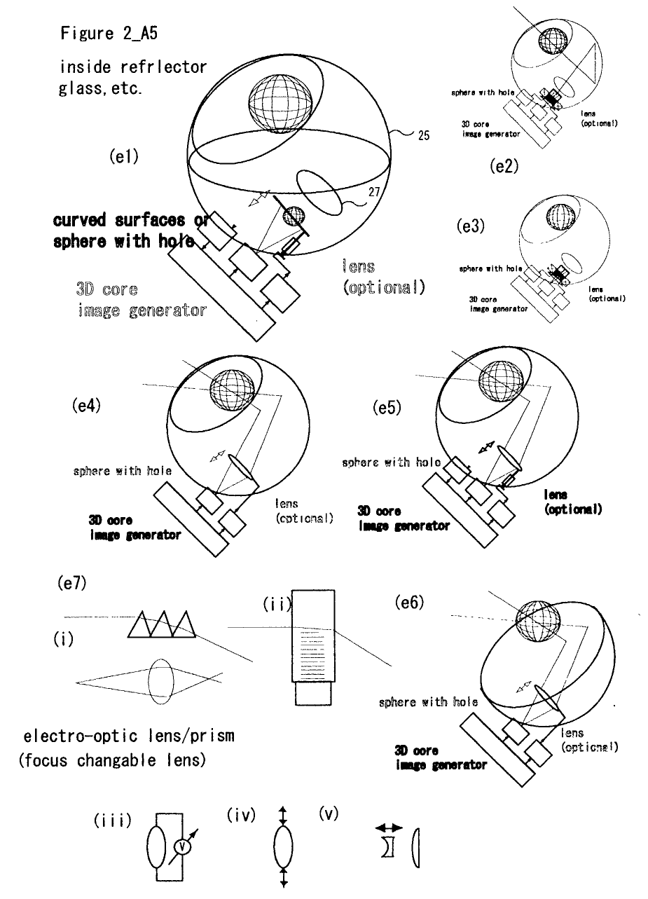

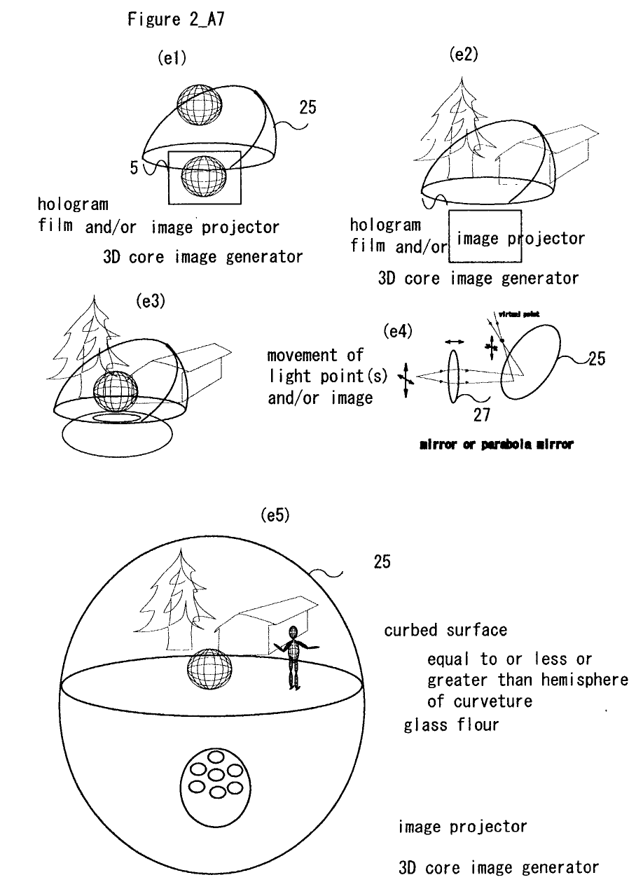

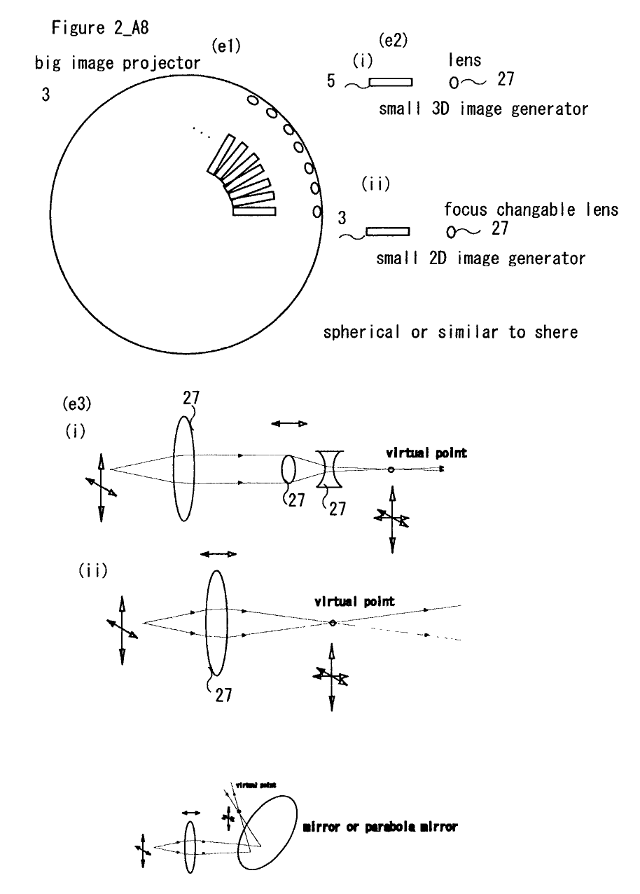

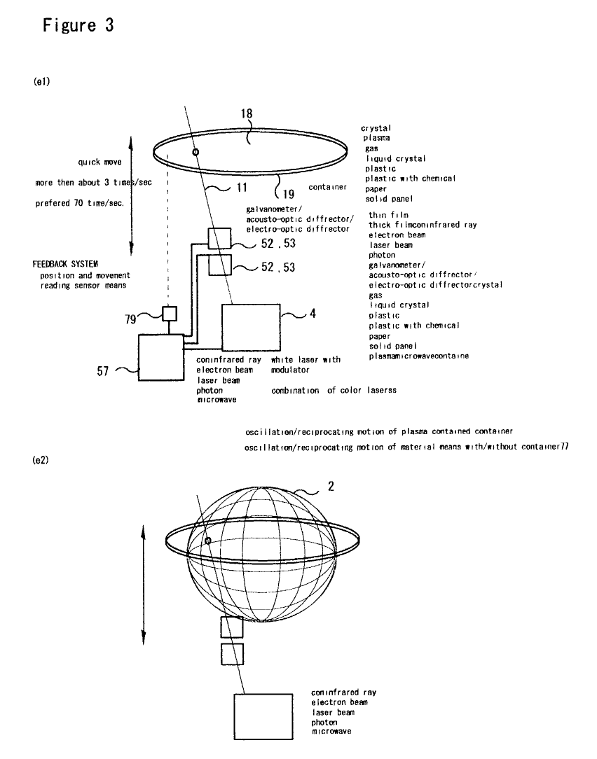

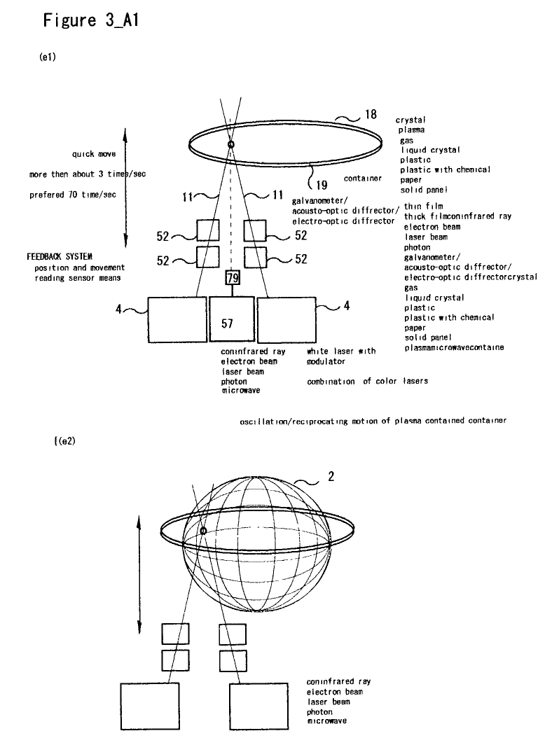

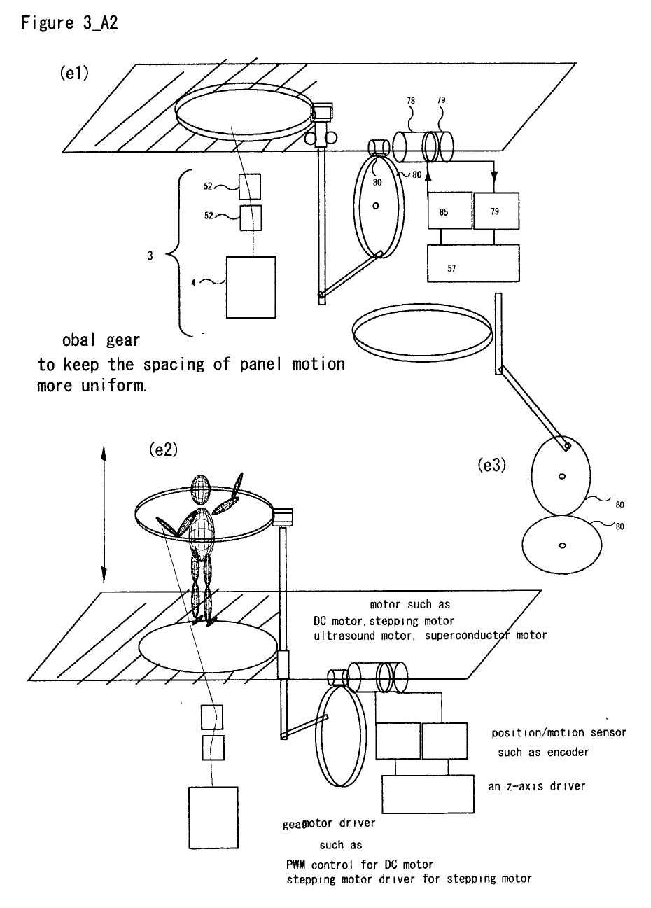

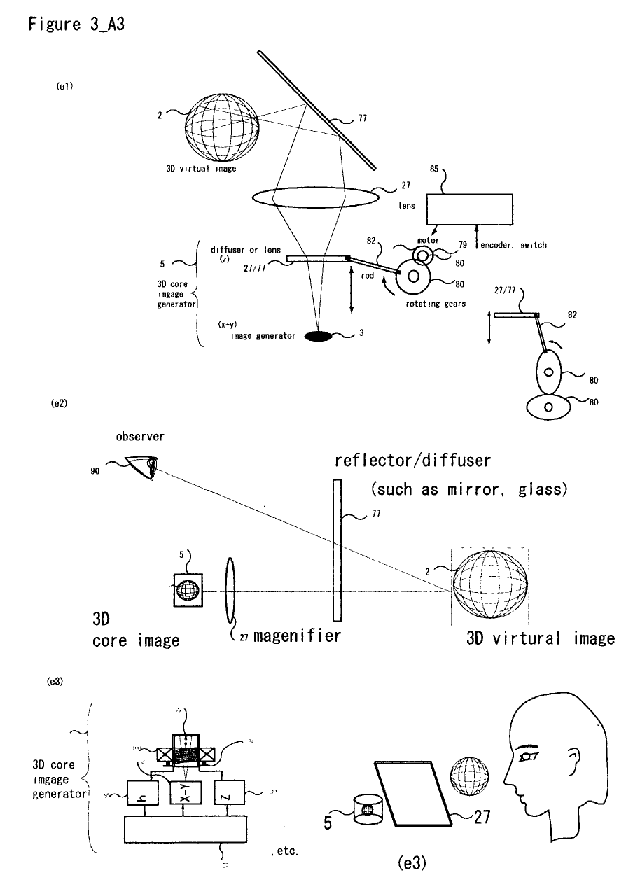

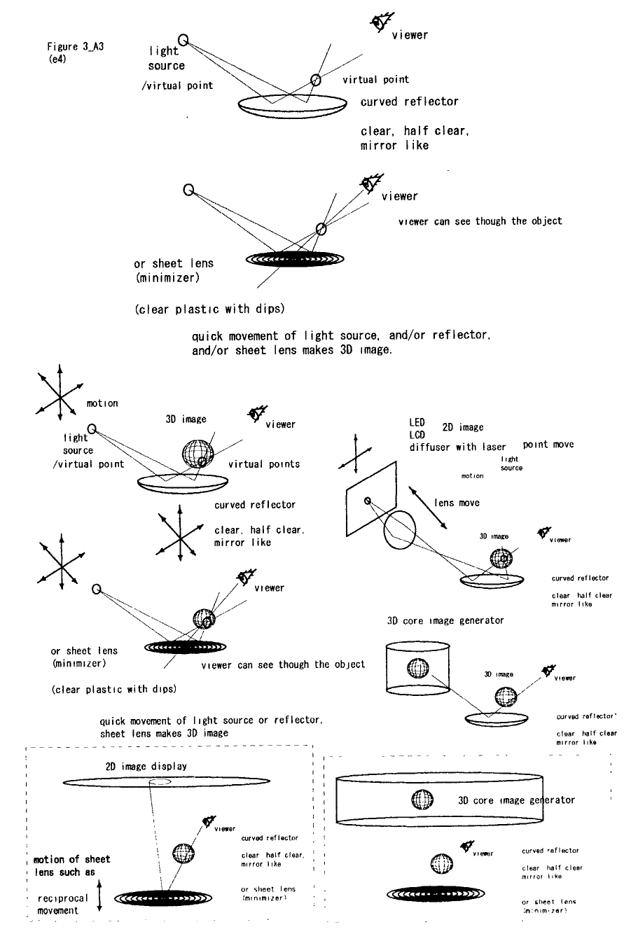

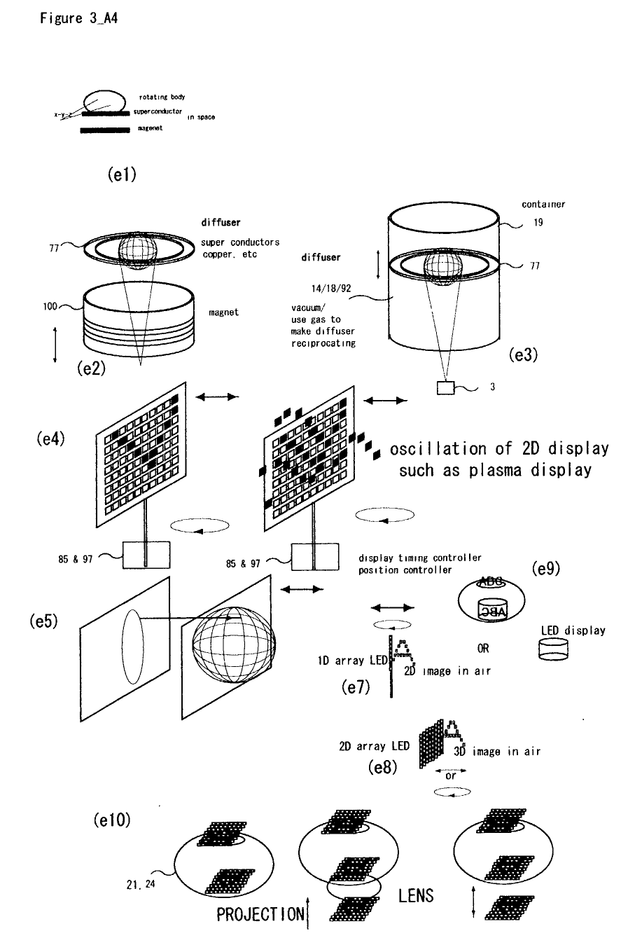

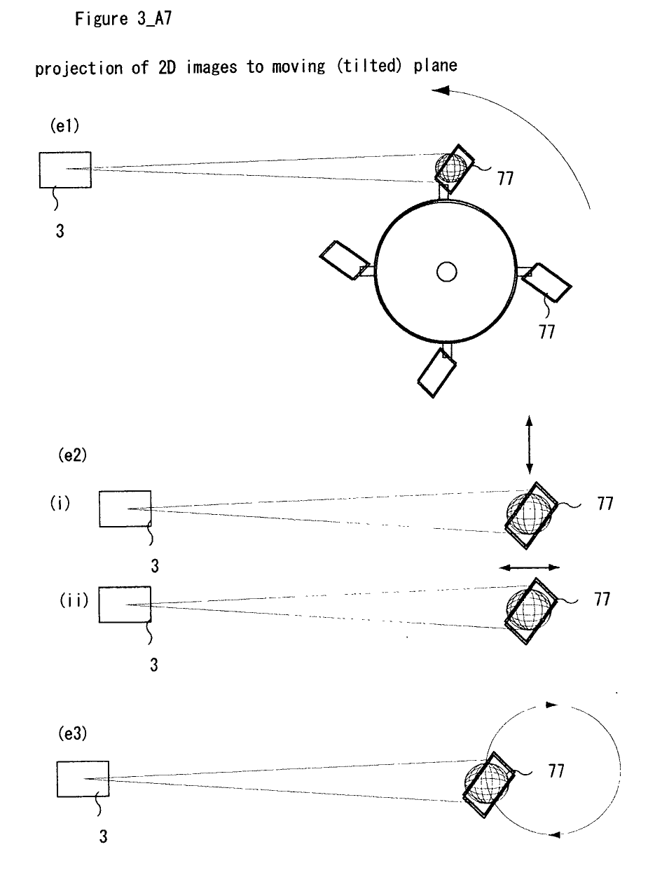

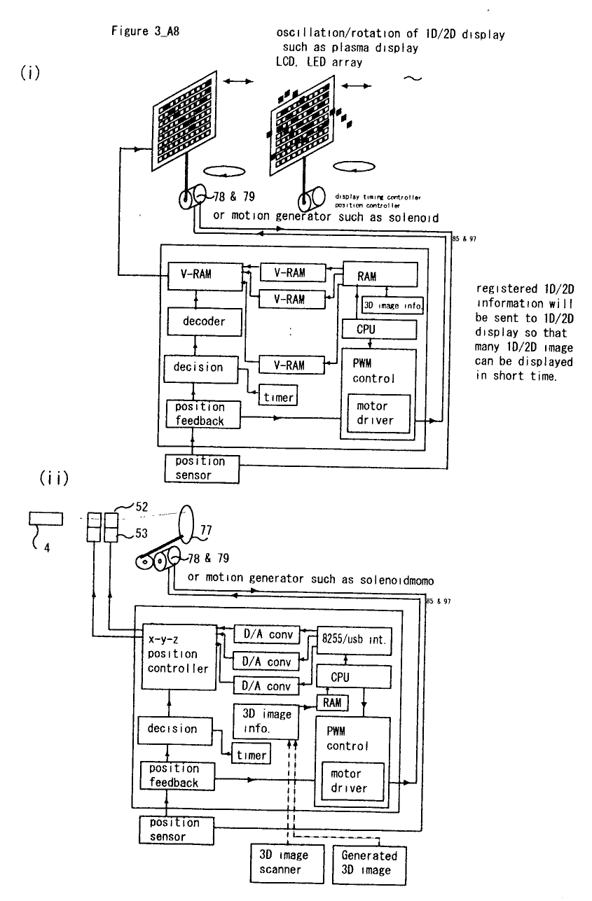

A preferred embodiment of the “3 dimensional image projector and holodeck” is illustrated in FIG. 1, FIG. 2, FIG. 3, FIG. 1_A3.

FIG. 1 shows the example diagram of 3 dimensional image projector means {1} displaying a 3D created image in the air. The 3 dimensional Image Generator of the type of FIG. 1_A3 (e1) has z axis control means {32} such as focusing beam means {8} such as microwave lens, and lens, magnet, and electric magnet together with beam direction changing means {52} such as x control means {30} and y control means {31} like polygon scanner, galvanometer with reflectors, acoustic crystal deflectors, electro-optic prisms/lenses, electric magnets.

The 3 dimensional Image Generator of the type of FIG. 1_A3 (e2) has multiple beam direction changing means {52} such as x, y, z axis control means {30,31,32} polygon scanner, galvanometer with reflectors, acoustic crystal deflectors, electro-optic prisms/lenses, electric magnets. Beam means {11} are emitted by the beam emitter means {4} such as microwave emitter, radio wave emitter, photon emitter, ion emitter, laser, white color laser, red laser, green laser, blue laser, infrared laser, ultraviolet-ray laser, x-ray laser, combination of those lasers. Beam means {11} are focused to a point so that the material means {18} such as air, gas, a crystal and crystals emits light and/or particles (photons). By moving this focused point rapidly, the device generates the 3D created image {2}.

FIG. 2 shows the example diagrams of 3D image generator means {1}. A material means {18} such as crystal, gas, and plasma with container means {19} with beam direction changing means {52} as x-y-z position controller {30,31,32} and their drivers that is contained by inside reflective curved surface with holes {22,23,24}. Beam emitters means {4} such as infrared beam emitter emit beam means {11} to couple or multiple on a x-y-z position in the material means {18} so that the material means {18} emit the light or particles means such as photons. Optionally, lens means {27} can be added to magnify the 3D core image. Ultrasound scanner {58} and a driver {57} acquire 3D image data and user interface input device means {70} are used to get input signal of a user such as his/her hand movements. In this example, a doctor is acquiring a 3D image of infant in a mother and displaying the infant and the doctor is measuring the size of the infant.

FIG. 3 shows the example diagrams of 3D image generator means {1}. The motion such as reciprocating motion and/or rotation with a material means {18} such as a layer/layers of crystal, gas, and plasma with/without container means {19} with beam direction changing means {52} such as acoustic-optic defector, electro-optic prism/lens, polygon scanner, galvanometer with reflector and their drivers, and the beam {11} entrance to the material means {18} of the motion like reciprocating and/or rotating motion generates the 3D created image {2}. The position and/or motion sensor and control means {79} detect the position and/or motion of the material means {18} send the position and/or motion information to the controller {57} as a feedback information and make decision from it.

FIGS. 1_A1 to 1_A4, 2_A1 to A_8, 3_A1 to 3_A8—Additional Embodiments

FIG. 1_A1 shows the example diagram of 3 dimensional image generator means {1}that create 3 dimensional created image {2} by focusing the beam emitted by beam emitter means {4} to a focus point in material means {18} and by moving the focus point controlled by x, y, and z axis control means with/without density control means {12}.

FIG. 1_A2 shows the example diagrams of the 3 dimensional image generator means {1} that create 3 dimensional created image {2} using container means {19} and material means {18} with/without image lifting means {21} such as inside reflective curved container means {22,23,24}, reflectors and lens.

FIG. 1_A3 shows the example diagrams of the more detail of 3 dimensional image generator means {1} that create 3 dimensional created image {2} by focusing the beam means {11} emitted by beam emitter means into material means {18} and by moving the focus point controlled by beam direction changing means {52} such as x, y, and z axis control {30,31,32} means with/without material density control.

FIG. 1_A4 shows the example diagram that plasma discharge and/or arc discharge {42} is used to create 3D created image {2} with example components of electrodes {37}, gas {18}, and the timing device for the pulse {57}.

FIG. 2_A1 shows the example component strabismus diagrams of 3D image generator means {1}.

FIG. 2_A2 shows the alternative example diagrams of 3D image generator means {1}.

Inside the image lifting means {20} and lens means {27}, (e1) has a fan {73} (e2) has a disk rotator {74}, (e3) has a diffuser {77}, (e4), (e7) and (e8) has oscillator made of material such as magnet means {100}.

FIG. 2_A3 shows the example diagrams of 3D image generator means {1} where beam means {11} enters material means {18} such as crystal, gas, and plasma with/without the usage of signal/information control means {98} such as PWM control.

FIG. 2_A4 shows the alternative example diagrams of 3D image generator means {1} with image lifting means {21} with magnification of 3D core image with different curvature (or dishes-like) reflective surfaces and lenses.

FIG. 2_A5 shows the alternative example diagrams of 3D image generator means {1} with different curvature (sphere/bowl/parabola-like) reflective surfaces with hole {25} and with/without magnification means such as lenses {27}.

FIG. 2_A7 shows the alternative example diagrams of 3D image generator means {1} comprising curvature (sphere/bowl/half dome/parabola-like) reflective surfaces {25} and 3D core image generator {5}.

FIG. 2_A8 (e1) shows the example diagrams of 3D image core generator {5} comprising many of small 3D image generator {5} and optical instruments such as lens means {27}

FIG. 2_A8 (e2) shows the example diagrams of 3D image core generator {5} comprising many of small 2D image generator {3} and optical instruments such as focus changeable lens means {27}.

FIG. 2_A8 (e3) and (e4) shows the example diagrams of focus changeable lens and the depth change of virtual point.

FIG. 3_A1 shows the example diagrams of 3D image generator means {1}. The motion such as reciprocating motion and/or rotation with a material means {18} such as a layer/layers of crystal, gas, and plasma with/without container means {19} with beam direction changing means {52} such as acoustic-optic defector, electro-optic prism/lens, polygon scanner, galvanometer with reflector and their drivers, and the multiple of beam means {11} entrance to the material means {18} of the motion like reciprocating and/or rotating motion generates the 3D created image {2}. The position and/or motion sensor and control means {79} detect the position and/or motion of the material means {18} send the position and/or motion information to the controller {57} as a feedback information and make decision from it.

FIG. 3_A2 shows the example mechanical diagrams of 3D image generator means {1}. The motion of a material means by the normal gears and/or oval gears {80}, rod means {82}, motor means {78}, position/motion control means {85} with position/motion sensing device {79} will give the 3d volumetric space to which 0 dimensional image (a point), 1D image, 2D image, and/or 3D image is projected by image projector {3} having beam direction changing means {52} and beam emitter {4}.

FIG. 3_A3 (e1) shows the alternative example diagrams of 3D image generator means {1}. The reflector means {77} brings image in the air and magnifier means such as lens, focus changeable lens {27} changes the size of the 3D created image generated by 3D core image generator {5}.

FIG. 3_A3 (e2) shows the alternative example diagrams of 3D image generator means {1}. The reflector means {77} reflect image in the air and magnifier means such as lens, focus changeable lens {27} changes the size of the 3D created image generated by 3D core image generator {5}.

FIG. 3_A3 (e3) shows the alternative example diagrams of 3D image generator means {1}. It has a lens between viewer and 3D core image generator. The figure shows how to bring 3D image, which is created by 3D core image generator, in front of viewer. Viewers can look at 3D created image in front of them. That is, they can interact with the 3D image with hands.

FIG. 2_A3 (e4) shows the alternative example diagrams of 3D image generator means {1}. It shows the movement of source light, a point light, laser beam, 1D image, 2D image, 3D image, images in general and/or the movement of curved reflector, parabola reflector, a sheet lens, a thin lens, a minimizing lens can create 3D created images. If the sheet lens, curved lens are clear, half clear, or half reflective viewers can look at the background sight as well.

FIG. 3_A4 (e1) and (e2) shows the alternative example diagrams of 3D image generator means {1}. The motion with a material means such as super conductor together with image projector can generate 3D created image. (e2) shows that the motion with a material means such as diffuser in vacuum or gas together with image projector can generate 3D created image. (e4), (e5), (e7), (e8) shows that the reciprocating/shift or ration motion of timed 1D/2D image can generate 2D13D created image. (e10) shows that 1D/2D display of still setting and/or motion in the image lifting means {21} can gives 1D/2D13D image.

FIG. 3_A5 shows the alternative example diagrams of 3D image generator means {1}. The reciprocating, and/or rotated motion of straight or tilted plane {77} with image projector or 2D display can generate the 3D created image.

FIG. 3_A8 shows the example diagrams of 3D image generator means and its drivers.

Other Figures—Alternative and Other Embodiment—and Examples

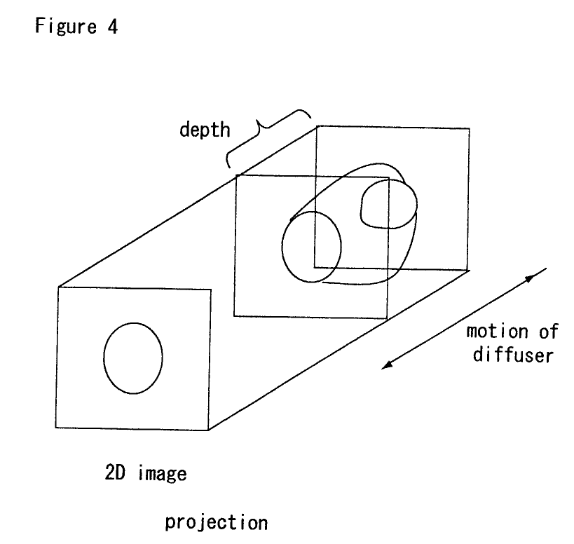

FIG. 4 is a copy of diagram drawing made by Kazutora Yoshino in 1995 showing the reciprocating motion of a screen with 2 dimensional image projected/generated can generate the 3D created image. In other words, moving images creates a higher dimensional image.

Advantages

As mentioned, this invention has advantages in

1. The device can display the 3 dimensional images immediately after the data has been acquired.

2. The device can display the 3 dimensional object or images that can be viewed by the multiple users without special glasses

3. The device can display the 3 dimensional object or images in the space.

4. The viewer may see the background sight s/he can see through 3D image.

5. Relatively, cost efficient.

6. It can run on complete system.

7. No container is necessary in the space for the 3D image.

8. Relatively brighter image than the most of the other 3D display.

9. Relatively clearer and higher resolution of 3D image.

10. Relatively smaller instrument and bigger 3D image.

Operation—FIG. 1, FIG. 2, FIG. 3_A8

One example of operation is that user can put the 3 dimensional image generator means in front of the objects, creatures such as user himself/herself and record the 3D video image. Then the recorded image can travel though network such as Internet to another 3D image generator means which displays the 3D image recorded either immediately or after some time. User can use this 3D image generator as data transform methods.

Another example of usage is that it can monitor the internal organs, infant in a mother of humans. The 3D data acquired from ultrasound scanner, CT scanner, X-rays can be sent to the 3D image generated by the 3D image generator.

Another example of usage is that engineer people can design objects interfacing directly with 3D image by their hand, input device, etc.

Another example of usage is that bioinformatists can design their proteins, drugs interfacing directly with 3D proteins/drug image by their hand, input device, etc.

Another example of usage is that people can put this device under a table with hole so that displayed 3D image shows up in the middle of table and can use as a general display.

Another way of using this device is that users teach their commands interacting with the invention by language or by visual language such as finger or hand movement. The device talks back to the users if its action is correct or how well done. Users gives response, and the invention learns the commands depending on the response. The invention shows what the invention is thinking by showing to the 3 dimensional virtual images to users. The invention can learn new materials by itself or by users visually looking at new materials or by listening sound, the language and music or by connecting to the information source such as electric dictionary or Internet.

Conclusion, Ramifications, and Scope

By this invention, multi-users can view the 3 dimensional objects or images in real time (run time) without special glasses in the space or in the air as the result of emitting light from virtual light emitting point. By this invention, users can view a baby's image in 3D in a mother.

I claim:

1. The three dimensional image generator means that creates three dimensional created images as the result of photons emissions from material means comprising physical material at points where beam means comprising beams of particles intersect.

2. The invention of claim of [1], wherein said beam means consisting the beams from the group consisting of
microwaves beam, radio wave beam, beam of photons, beam of electrons, beam of ions, red laser beam, green laser beam, blue laser beam, infrared laser beam, ultraviolet laser beam, x-ray laser beam and combination of such beams.

3. The invention of claim of [1], wherein said material means consisting the beams from the group consisting of
air, plasma materials, gas materials, liquid materials, solid materials, a crystal, layers of crystals, liquid crystal, liquid materials, solid materials, organic materials, paper, plastic, glass, plastic with chemical materials, glass with chemical materials, silicon, thin film, thick film, liquid, solid, air, argon, helium, superconductors.

4. The invention of claim of [1], wherein said 3 dimensional image generator means comprising the devices selected from the group consisting of
three dimensional image scanners comprising the devices selected from the group consisting of
laser scanner, video scanner, two video scanner, scanning camera, two scanning cameras, ultrasound scanner, and cat scanner
beam emitter means comprising the devices selected from the group consisting of
electron beam emitters and ion beam emitters, and photon emitters comprising the devices selected from the group consisting of
radio wave generator, infrared light generator, ultraviolet light generator and light generator
beam direction changing means comprising the devices selected from the group consisting of
polygon scanner, galvanometer with reflector such as mirror, acousto-optic deflector, electro-optic prism, electro-optic lens
drivers for beam direction changing means
focusing beam means comprising the devices selected from the group consisting of
lens, magnet, electric magnet, electric field, magnetic field and reflective surface, polygon scanner, galvanometer with reflector such as mirror, acousto-optic deflector, electro-optic prism, electro-optic lens
drivers for said focusing beam means
pressure control means comprising the devices selected from the group consisting of vacuum pump and fan
material means comprising materials selected from the group comprising of
air, plasma materials, gas materials, liquid materials, solid materials, a crystal, layers of crystals, liquid crystal, liquid materials, solid materials, organic materials, paper, plastic, glass, plastic with chemical materials, glass with chemical materials, silicon, thin film, thick film, liquid, solid, air, argon, helium, superconductors.

5. The invention of claim of [1], wherein said three dimensional image generator means comprising the devices selected from the group consisting of
three dimensional image scanners comprising the devices selected from the group consisting of
laser scanner, video scanner, two video scanner, scanning camera, two scanning cameras, ultrasound scanner, and cat scanner
beam emitter means comprising the devices selected from the group consisting of
electron beam emitters and ion beam emitters, and photon emitters comprising the devices selected from the group consisting of
radio wave generator, infrared light generator, ultraviolet light generator and light generator
beam direction changing means comprising the devices selected from the group consisting of
polygon scanner, galvanometer with reflector such as mirror, acousto-optic deflector, electro-optic prism, electro-optic lens
drivers for beam direction changing means
focusing beam means comprising the devices selected from the group consisting of
lens, magnet, electric magnet, electric field, magnetic field and reflective surface, polygon scanner, galvanometer with reflector such as mirror, acousto-optic deflector, electro-optic prism, electro-optic lens
drivers for said focusing beam means
pressure control means comprising the devices selected from the group consisting of vacuum pump and fan
material means comprising materials selected from the group comprising of
air, plasma materials, gas materials, liquid materials, solid materials, a crystal, layers of crystals, liquid crystal, liquid materials, solid materials, organic materials, paper, plastic, glass, plastic with chemical materials, glass with chemical materials, silicon, thin film, thick film, liquid, solid, air, argon, helium, superconductors.
Optional container means comprising containers selected from the group comprising of
no container, container in general, glass container, plastic container, inside reflective container.

6. The invention of claim of [1], wherein said three dimensional image generator means comprising the device for creating three dimensional image with the plurality of points at which photons emit due to the projection of beams.

7. The invention of claim of [1], wherein said three dimensional image generator means comprising the devices for creating three dimensional image by moving a point, where photons emit, quickly enough for eyes to see said point as points in space whereby viewers see said point with motion as three dimensional images in space.

8. The invention of claim [1], wherein said 3 dimensional image generator means comprising the devices selected from the group consisting of
plasma jet comprising the parts selected from the group consisting of anode, cathode, camber, gas, air, power supply and magnet, electric magnet
image projector comprising the devices selected from the group consisting of
a point image projector,
zero dimensional image projectors,
one dimensional image projector,
two dimensional image projector,
three dimensional image projector

9. The invention of claim [1], wherein said 3 dimensional image generator means comprising the devices selected from the group consisting of
electrodes
gas
pulse timing device and the driver electrode moving device and the driver

10. The three dimensional image generator means that creates three dimensional created images as the result of the image lifting means comprising of optical instruments and three dimensional core image generator means comprising devices for creating first stage three dimensional images.

11. The invention of claim [10], wherein said image lifting means is composed of the devices selected from the group consisting of
inside reflective curved surface container with holes,
inside reflective curved surface,
lens means comprising the parts selected from the group consisting of
optical lens, focus changeable lens, electro-optic lens, mechanical focus changeable lens.

12. The invention of claim of [10], wherein said three dimensional core image generator means comprising the devices selected from the group consisting of
three dimensional image scanners comprising the devices selected from the group consisting of
laser scanner, video scanner, two video scanner, scanning camera, two scanning cameras, ultrasound scanner, and cat scanner
beam emitter means comprising the devices selected from the group consisting of
electron beam emitters and ion beam emitters, and photon emitters comprising the devices selected from the group consisting of
radio wave generator, infrared light generator, ultraviolet light generator and light generator
beam direction changing means comprising the devices selected from the group consisting of
polygon scanner, galvanometer with reflector such as mirror, acousto-optic deflector, electro-optic prism, electro-optic lens
drivers for beam direction changing means
focusing beam means comprising the devices selected from the group consisting of
lens, magnet, electric magnet, electric field, magnetic field and reflective surface, polygon scanner, galvanometer with reflector such as mirror, acousto-optic deflector, electro-optic prism, electro-optic lens
drivers for said focusing beam means
pressure control means comprising the devices selected from the group
consisting of vacuum pump and fan
material means comprising materials selected from the group comprising of
air, plasma materials, gas materials, liquid materials, solid materials, a crystal, layers of crystals, liquid crystal, liquid materials, solid materials, organic materials, paper, plastic, glass, plastic with chemical materials, glass with chemical materials, silicon, thin film, thick film, liquid, solid, air, argon, helium, superconductors.
Optional container means comprising containers selected from the group comprising of
no container, container in general, glass container, plastic container, inside reflective container.

13. The invention of claim of [10], wherein said 3 dimensional core image generator means comprising the devices selected from the group consisting of
three dimensional image scanners comprising the devices selected from the group consisting of
laser scanner, video scanner, two video scanner, scanning camera, two scanning cameras, ultrasound scanner, and cat scanner
beam emitter means comprising the devices selected from the group consisting of
electron beam emitters and ion beam emitters, and photon emitters comprising the devices selected from the group consisting of
radio wave generator, infrared light generator, ultraviolet light generator and light generator
beam direction changing means comprising the devices selected from the group consisting of
polygon scanner, galvanometer with reflector such as mirror, acousto-optic deflector, electro-optic prism, electro-optic lens
drivers for beam direction changing means
focusing beam means comprising the devices selected from the group consisting of
lens, magnet, electric magnet, electric field, magnetic field and reflective surface, polygon scanner, galvanometer with reflector such as mirror, acousto-optic deflector, electro-optic prism, electro-optic lens
drivers for said focusing beam means
pressure control means comprising the devices selected from the group consisting of vacuum pump and fan
material means comprising materials selected from the group comprising of
air, plasma materials, gas materials, liquid materials, solid materials, a crystal, layers of crystals, liquid crystal, liquid materials, solid materials, organic materials, paper, plastic, glass, plastic with chemical materials, glass with chemical materials, silicon, thin film, thick film, liquid, solid, air, argon, helium, superconductors.
material motion generators means comprising the devices for moving the material means.
image projector means comprising the devices for projecting images to material means.
Optional container means comprising containers selected from the group comprising of
no container, container in general, glass container, plastic container, inside reflective container.

14. The three dimensional image generator means comprising systems and apparatuses selected from the group consisting of
beam emitter means comprising devices for emitting beams of particles
beam direction changing means comprising devices for changing the direction of said beams of particles.
driver means for said beam direction changing means comprising devices for controlling said beam direction changing means
material means comprising physical materials
container means comprising containers for holding and containing said material means
material motion generators means comprising mechanisms for making said material means to have motions
image projector means comprising the devices for projecting images to material means.
sensor means comprising devices for receiving information inside of said system.
input device means comprising devices for receiving information from outside of said system.
controller means comprising controllers for controlling said system

15. The invention of the claim [14], wherein said beam emitter means comprising devices selected from the group of
photon emitter means comprising emitters selected from the group of
lasers, microwave emitters, radio wave emitters, light emitters
electron beam emitters, ion beam emitters, and particles emitters.

16. The invention of the claim [14], wherein said beam direction changing means comprising devices selected from the group consisting of
photon direction changing means comprising the devices selected from the group consisting of
polygon scanner, galvanometers with reflectors, acousto-optic deflectors, electro-optic prisms, electro-optic lens, mirrors, lenses
magnetic field generator
electric field generator

17. The invention of the claim [14], wherein said material means comprising materials selected from the group consisting of
a crystal, layers of crystals, liquid crystal, plasmas, gas materials, liquid materials, solid materials, organic materials, paper, plastic, glass, plastic with chemical materials, glass with chemical materials, silicon, thin film, thick film, liquid, solid, air, argon, helium, superconductors.

18. The invention of the claim [14], wherein said material motion generators means comprising devices selected from the group of devices consisting of
reciprocating motion means comprising devices selected from the group consisting of
reciprocating motion of straight panel of said material means,
reciprocating motion of curved surface of said material means,
reciprocating motion of tilted surface of said material means
rotating motion means comprising devices selected from the group consisting of
rotator with plates of said material means,
rotator with a plate of said material means,
rotating motion of straight panel of said material means,
rotating motion of curved surface of said material means,
rotating motion of tilted surface of said material means

19. The invention of the claim [14], wherein said material motion generators means comprising devices selected from the group consisting of
motion starting means comprising devices selected from the group consisting of
motor means comprising devices selected from the group consisting of
general motors, direct current motors, alternating current motors, stepping motors ultrasound motors
solenoid means comprising devices selected from the group consisting of
solenoid, speaker, speaker-like mechanism
driver means for said motion starting means comprising devices selected from the group consisting of
pulse width method driver, direct current motor driver,
alternating current motor driver, stepping motor driver,
solenoid driver, ultrasound motor driver, speaker driver
gear means comprising gears selected from the group consisting of gears, oval gears, and spiral gears
rod means comprising rods and plates
sliding holder means comprising parts selected from the
group consisting of columns, corns, pipes, bearings, and pistons
power means comprising parts selected from the group consisting of
powers, battery, capacitor, solar power panel, hydrogen, energy holder, materials capable of generating and saving energy.

20. The invention of the claim [14], wherein said image projector means comprising devices selected from the group consisting of
a point image projectors,
zero dimensional image projectors,
one dimensional image projectors,
two dimensional image projectors,
three dimensional image projectosr

21. The invention of the claim [14], wherein said sensor means comprising devices selected from the group consisting of
photodiodes, phototransistors, encoders, potentiometers, switches, motion sensors, ultrasound sensors, light emitter with photodiodes.

22. The invention of the claim [14], wherein said input device means comprising devices selected from the group consisting of
image scanner, three dimensional image scanner, ultrasound three dimensional image scanner, laser scanner, videos, three dimensional videos, cameras, three dimensional cameras, motion sensors, photodiodes, phototransistors, encoders, potentiometers, switches, motion sensors

23. The invention of the claim [14], wherein said controller means comprising devices selected from the group consisting of
computers, central processing units, random accessing memory, input output interface, digital analog converter, frequency voltage converter, timer, amplifier, transistor, capacitor, resistors, integrated circuit, pulse width method driver, drivers, software.
